(19) United States
(12) Patent Application Publication
(10) Pub. No.: US 2019/0091901 A1
(43) Pub. Date: Mar. 28, 2019

(54) SUPERCRITICAL FLUID MICROCELLULAR INJECTION MOLDING EQUIPMENT AND INJECTION MOLDING METHOD THEREOF

(71) Applicant: VIGOURPLASTIC CO., LTD., Lukang Township (TW)

(72) Inventor: Albert HSIEH, Lukang Township (TW)

(21) Appl. No.: 15/713,082

(22) Filed: Sep. 22, 2017

(51) Int. Cl. B29C 44/34; B29B 13/02; B29C 45/72

(52) U.S. Cl. CPC B29C 44/348; C08J 2203/00; B29C 45/72; B29B 13/022

(57) ABSTRACT

A supercritical fluid microcellular injection molding method includes the following steps. Preheating: the feed pipe is preheated to a hot melt temperature of polymer. Feeding: the polymer is poured into the hopper and enters the feed pipe. A metering screw is rotatably received in the feed pipe for forwardly pushing the hot molten polymer when being rotated. Injecting SCF: the SCF is injected into the feed pipe and mixed with the hot molten polymer into a homogeneous monophasic fluid. Quantitative discharge and depressurization: the monophasic fluid flows across a first gear pump and a second gear pump mounted on the front end of the feed pipe. Discharging and molding: the monophasic fluid actuated by the first gear pump and the second gear pump is injected and molded by the die head fixed to the discharge end of the second gear pump.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present invention relates to the technical field of injection molding, and more particularly to equipment and a method for supercritical fluid microcellular injection molding.

### 2. Description of Related Art Including Information Disclosed Under 37 CFR 1.97 and 37 CFR 1.98.

The conventional foam plastic is mostly made by using physical or chemical additives, wherein gases is released and crafters are formed in the foam plastic during a heating process. As the gasification process is drastic and the temperature distribution in the end product is not uniform such that the crafters are relatively large. In recent years, a new method is provided to replace the conventional foaming agent by supercritical fluid (SCF). The bubble particles are minute, the distribution density is very high and uniform, and the original physical properties of plastics will not be degraded because the phase separation is formed spontaneously and rapidly by the thermodynamic instability resulted from the depressurization cycle.

This technology can improve the conventional plastic foaming method, but it is inapplicable to producing high density styrofoam plates because the surface of the polystyrene plates produced by using the existing supercritical fluid microcellular injection molding method is likely to contract to form wrinkles. The formed wrinkles are very likely to form wavy lines on the surface and influencing the quality of the product after flattening procedure.

The present invention has arisen to mitigate and/or obviate the disadvantages of the conventional injection molding method and products thereof.

### BRIEF SUMMARY OF THE INVENTION

The main objective of the present invention is to provide an improved method and equipment for supercritical fluid microcellular injection molding.

To achieve the objective, the supercritical fluid microcellular injection molding method in accordance with the present invention comprises the following steps. Preheating feed pipe: a feed pipe is preheated to a hot melt temperature of polymer. Feeding: polymer is poured into the hopper and enters the feed pipe. An actuating unit is mounted on the feed pipe drives a metering screw rotatably received in the feed pipe. The metering screw is rotated against the feed pipe for forwardly pushing the hot molten polymer to the front end of the feed pipe. Injecting SCF: the SCF is injected into the feed pipe. The metering screw is rotated and mixes the SCF with the hot molten polymer into a homogeneous monophasic fluid. Quantitative discharge and depressurization: the homogeneous monophasic fluid mixed of the SCF and the hot molten polymer flows along the discharge runner through a first gear pump and a second gear pump that are sequentially mounted to a front end of the feed pipe. The first gear pump is provided to maintain the discharge rate per unit time of the discharge runner and the second gear pump reduces a pressure of the monophasic fluid before the monophasic fluid molding because the second gear pump has a feed rate higher than a discharge rate of the first gear pump. Discharging and molding: the monophasic fluid, after being actuated by the first gear pump and the second gear pump, is discharged and molded by the die head mounted on a discharge end of the second gear pump. The gas, in the monophasic fluid, is diffused and nucleated in the molten plastic and grows into uniform microbubbles, after leaving the dishead due to an instant pressure drop state in the discharging process resulting in thermodynamic unbalance, and the plastic with microbubbles is cooled and solidified to obtain the end product of microcellular foam.

Further benefits and advantages of the present invention will become apparent after a careful reading of the detailed description with appropriate reference to the accompanying drawings.

### BRIEF DESCRIPTION OF THE SEVERAL VIEWS OF THE DRAWINGS

FIG. 1 shows the hardware facilities of a supercritical fluid microcellular injection molding method in accordance with the present invention.

FIG. 2 is the flowchart of a supercritical fluid microcellular injection molding method in accordance with the present invention.

### DETAILED DESCRIPTION OF THE INVENTION

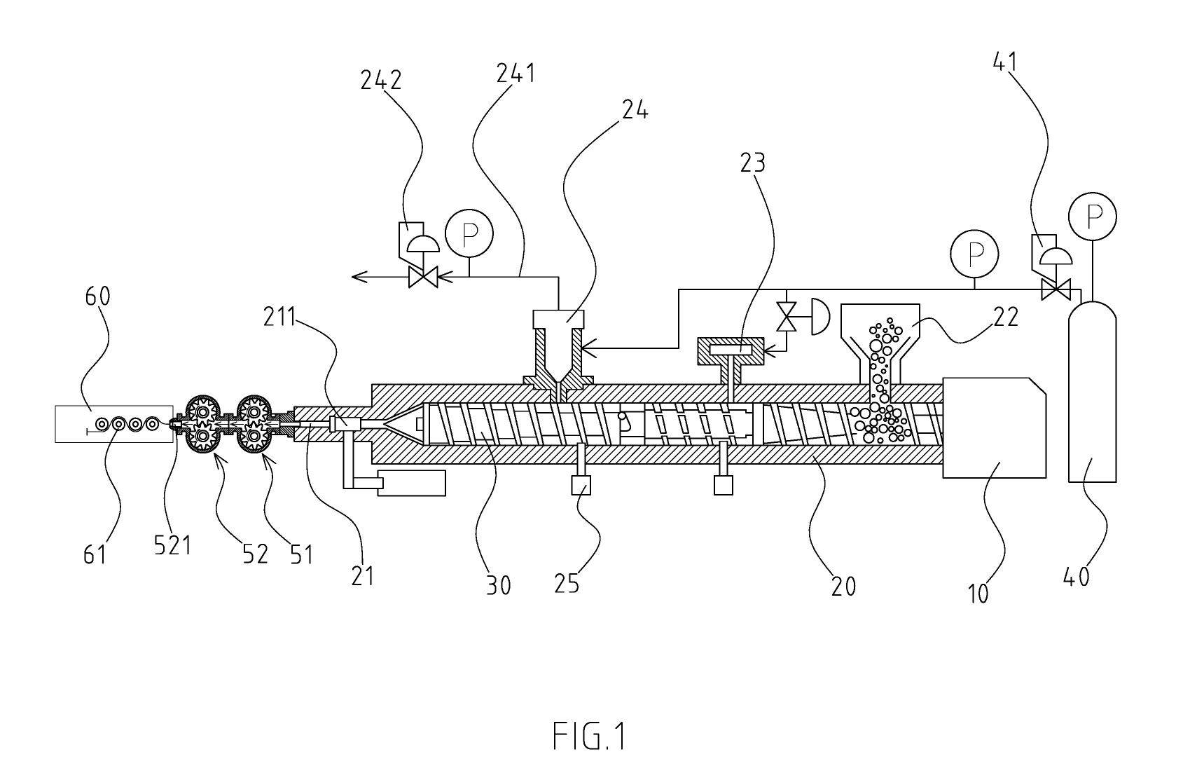

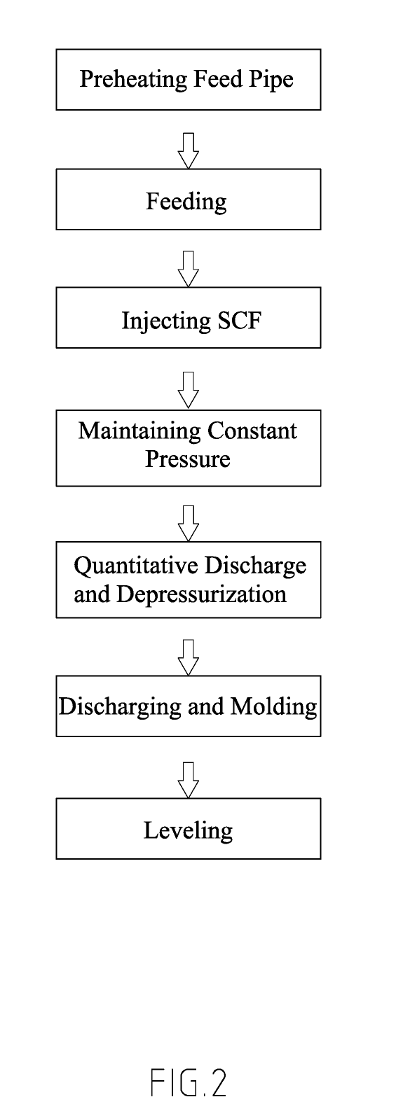

FIGS. 1 and 2 show a preferred embodiment of a supercritical fluid microcellular injection molding method and equipment of the present invention. The following description only describes the equipment and method in accordance with present invention, but not limits to the structures and steps, as described hereinafter. Referring to FIG. 1, the equipment of the supercritical fluid microcellular injection molding method in accordance with the present invention includes an actuating unit 10, a feed pipe 20 axially mounted to the actuating unit 10 and a metering screw 30 rotatably received in the feed pipe 20, wherein the metering screw 30 is axially connected to the actuating unit 10 and driven by the actuating unit 10. A discharge runner 21 is axially defined in a front end of the feed pipe 20. A shut-off valve 211 is mounted in the discharge runner 21. The shut-off valve 211 interrupts the discharge runner 21 temporarily and selectively. A hopper 22, an injection valve 23 and an exhaust structure 24 are respectively and sequentially mounted onto the feed pipe 20 from a rear end to a front end of the feed pipe 20. The hopper 22 is adapted to feed polymers into the feed pipe 20. The exhaust structure 24 is communicated with an inner periphery of the feed pipe 20. The injection valve 23 and the exhaust structure 24 are connected to a high pressure gas source 40 respectively, and a pressure reducing valve 41 is mounted between the injection valve 23 and the high pressure gas source 40. An exhaust line 241 is connected to the exhaust structure 24 and a back pressure regulator 242 is disposed on the exhaust line 241. At least one pressure sensor 25 is mounted to the feed pipe 20 and the back pressure regulator 242 is electrically connected to the at least one pressure sensor 25.

A first gear pump 51 and a second gear pump 52 are sequentially mounted to the front end of the feed pipe 20. The first gear pump 51 has a rotary speed lower than that of the second gear pump 52, and the first gear pump 51 and the second gear pump 52 are provided with a feed end and a discharge end respectively. The feed end of the first gear pump 51 and the discharge runner 21 are interconnected and the discharge end of the first gear pump 51 is connected to the feed end of the second gear pump 52. A die head 521 is mounted onto the discharge end of the second gear pump 52 for injection molding. In addition, the equipment in accordance with the present invention further includes a leveling device 60 coupled with the die head 521. The leveling device 60 comprises multiple rotating rollers 61 situated on a same plan and synchronously operated. In the preferred embodiment of the present invention, the feed rate of the second gear pump 52 is higher than the discharge rate of the first gear pump 51. There are two technical means to implement this effect. Firstly, the feed-discharge ratio of the first gear pump 51 is equivalent to that of the second gear pump 52 and the rotary speed of the second gear pump 52 is higher than the rotary speed of the first gear pump 51. Secondly, the first gear pump 51 and second gear pump 52 have the same rotary speed, and the feed-discharge ratio of the second gear pump 52 is higher than the feed-discharge ratio of the first gear pump 51.

Referring to FIG. 2, the supercritical fluid microcellular injection molding method in accordance with the present invention comprises the following steps.

Preheating a feed pipe 20: the feed pipe 20 is preheated to a hot melt temperature of the polymer to be used, as to produce high density styrofoam plates, the polystyrene (PS) at melting point about 240° C. is used such that the preheating temperature of the feed pipe 20 is set about 240° C. In addition, the glass transition temperature of the polystyrene is higher than 100° C., so that the styrofoam plates produced by the method in accordance with the present invention are capable of making various wash-free containers (tableware and the like) that resistant to a high temperature.

Feeding: the polymer is poured into the hopper 22 and enters the feed pipe 20. Meanwhile the actuating unit 10 drives the metering screw 30 and the metering screw 30 rotates against the feed pipe 20 for forwardly pushing the hot molten polymer to the front end of the feed pipe 20.

Injecting SCF: the injection valve 23 is turn on to inject the SCF (N₂ or CO₂), supplied from the high pressure gas source 40, into feed pipe 20. The metering screw 30 is rotated and mixes the SCF with the hot molten polymer into a homogeneous monophasic fluid. The supply pressure is about 12 Mpa when the SCF, supplied from the high pressure gas source 40, is N₂ and the supply pressure is 5-6 Mpa when the SCF, supplied from the high pressure gas source 40, is CO₂. A pressure reducing valve 41 is disposed between the injection valve 23 and the high pressure gas source 40 such that the high pressure liquid gas, supplied from the high pressure gas source 40, is depressurized into a gas-liquid coexistent supercritical state under the regulating effect of the pressure reducing valve 41, which is injected through the injection valve 23 into the feed pipe 20, wherein the output pressure value of exit end is kept automatically by the structure property of pressure reducing valve 41.

Maintaining constant pressure: the feed pipe 20 is provided with at least one pressure sensor 25 and the back pressure regulator 242, connected via exhaust line 241 to the exhaust structure 24, is electrically connected to the at least one pressure sensor 25. The back pressure regulator 242 opens the exhaust line 241 to relieve the pressure in the feed pipe 20 when the pressure in the feed pipe 20, detected by the at least one pressure sensor 25, is higher than the maximum value of the preset operating pressure. The back pressure regulator 242 closes the exhaust line 241 to keep the operating pressure in the feed pipe 20 in the tolerant pressure range when the pressure in the feed pipe 20 detected by the at least one pressure sensor 25 is lower than the minimum value of the preset operating pressure.

Quantitative discharge and depressurization: the homogeneous monophasic fluid mixed of the SCF and the hot molten polymer flows along the discharge runner 21 through the first gear pump 51 and the second gear pump 52. The major function of the first gear pump 51 is to maintain the discharge rate per unit time of the discharge runner 21 and the second gear pump 52 reduces the pressure of the monophasic fluid before the monophasic fluid molding because the second gear pump 52 has a rotary speed higher than that of the first gear pump 51.

Discharging and molding: the monophasic fluid, after being actuated by the first gear pump 51 and the second gear pump 52, is discharged and molded by the die head 521. The gas, in the monophasic fluid, is diffused and nucleated in the molten plastic, and grows into uniform microbubbles after leaving the die head 521 due to an instant pressure drop state in the discharge process resulting in thermodynamic unbalance. Furthermore, the plastic with microbubbles is cooled and solidified to obtain the end product of microcellular foam (styrofoam plate).

Leveling: the cooled plate, injected from the die head 521, crosses the multiple rotating rollers 61 in waves for leveling operation, and eliminating a stress of the plate after molding and the warpage resulted from the stress.

The method in accordance with the present invention uses the depressurization resulted from the speed difference between the first gear pump 51 and the second gear pump 52 to eliminate the contraction induced wrinkles on the surface of styrofoam plates produced through conventional process, so that the subsequent molded products are free of unwanted lines, the added value of polystyrene plates is increased, and the marketability of subsequent molded products is enhanced.

Although the invention has been explained in relation to its preferred embodiment, it is to be understood that many other possible modifications and variations can be made without departing from the spirit and scope of the invention as hereinafter claimed.

I claim:

1. A supercritical fluid microcellular injection molding method comprising the following steps:
preheating feed pipe: a feed pipe being preheated to a hot melt temperature of polymer;
feeding: polymer poured into the hopper and entering the feed pipe, an actuating unit mounted on the feed pipe driving a metering screw rotatably received in the feed pipe, the metering screw rotated against the feed pipe for forwardly pushing the hot molten polymer to the front end of the feed pipe;
injecting SCF: the SCF injected into the feed pipe, the metering screw rotated and mixing the SCF with the hot molten polymer into a homogeneous monophasic fluid;
quantitative discharge and depressurization: the homogeneous monophasic fluid mixed of the SCF and the hot molten polymer flowing along the discharge runner through a first gear pump and a second gear pump that are sequentially mounted to a front end of the feed pipe; the first gear pump provided to maintain the discharge rate per unit time of the discharge runner, the second gear pump reducing a pressure of the monophasic fluid before the monophasic fluid molding because the second gear pump has a feed rate higher than a discharge rate of the first gear pump; and
discharging and molding: the monophasic fluid, after being actuated by the first gear pump and the second gear pump, discharged and molded by the die head mounted on a discharge end of the second gear pump, the gas, in the monophasic fluid, diffused and nucleated in the molten plastic and growing into uniform microbubbles, after leaving the die head due to an instant pressure drop state in the discharging process resulting in thermodynamic unbalance, and the plastic with microbubbles being cooled and solidified to obtain the end product of microcellular foam.

2. The method as defined in claim 1, wherein the first gear pump and the second gear pump have a same feed-discharge ratio, and a rotary speed of the second gear pump is higher than that of the first gear pump.

3. The method as defined in claim 1, wherein the first gear pump and the second gear pump have a same rotary speed, and the feed-discharge ratio of the second gear pump is higher than that of the first gear pump.

4. The method as defined in claim 1, wherein an injection valve is mounted onto the feed pipe and connected to a high pressure gas source, a pressure reducing valve mounted between the injection valve and the high pressure gas source; the high pressure liquid gas from the high pressure gas source depressurized into a gas-liquid coexistent supercritical state under the regulating effect of the pressure reducing valve, which is injected through the injection valve into the feed pipe, wherein the output pressure value of exit end is maintained automatically by the structure property of pressure reducing valve.

5. The method as defined in claim 2, wherein an injection valve is mounted onto the feed pipe and connected to a high pressure gas source, a pressure reducing valve mounted between the injection valve and the high pressure gas source; the high pressure liquid gas from the high pressure gas source depressurized into a gas-liquid coexistent supercritical state under the regulating effect of the pressure reducing valve, which is injected through the injection valve into the feed pipe, wherein the output pressure value of exit end is maintained automatically by the structure property of pressure reducing valve.

6. The method as defined in claim 3, wherein an injection valve is mounted onto the feed pipe and connected to a high pressure gas source, a pressure reducing valve mounted between the injection valve and the high pressure gas source; the high pressure liquid gas from the high pressure gas source depressurized into a gas-liquid coexistent supercritical state under the regulating effect of the pressure reducing valve, which is injected through the injection valve into the feed pipe, wherein the output pressure value of exit end is maintained automatically by the structure property of pressure reducing valve.

7. The method as defined in claim 4 further comprising a step of maintaining constant pressure between the steps of injecting SCF and the quantitative discharge and depressurization, wherein the feed pipe is provided with at least one pressure sensor and the back pressure regulator, connected to the exhaust structure via the exhaust line, is electrically connected to the at least one pressure sensor; the back pressure regulator opening the exhaust line to relieve the pressure in the feed pipe when the pressure, in the feed pipe detected by the at least one pressure sensor, is higher than a maximum value of the preset operating pressure; the back pressure regulator closing the exhaust line to keep an operating pressure in the feed pipe in tolerant pressure range when the pressure, in the feed pipe detected by the at least one pressure sensor, is lower than a minimum value of the preset operating pressure.

8. The method as defined in claim 5 further comprising a step of maintaining constant pressure between the steps of injecting SCF and the quantitative discharge and depressurization, wherein the feed pipe is provided with at least one pressure sensor and the back pressure regulator, connected to the exhaust structure via the exhaust line, is electrically connected to the at least one pressure sensor; the back pressure regulator opening the exhaust line to relieve the pressure in the feed pipe when the pressure, in the feed pipe detected by the at least one pressure sensor, is higher than a maximum value of the preset operating pressure; the back pressure regulator closing the exhaust line to keep an operating pressure in the feed pipe in tolerant pressure range when the pressure, in the feed pipe detected by the at least one pressure sensor, is lower than a minimum value of the preset operating pressure.

9. The method as defined in claim 6 further comprising a step of maintaining constant pressure between the steps of injecting SCF and the quantitative discharge and depressurization, wherein the feed pipe is provided with at least one pressure sensor and the back pressure regulator, connected to the exhaust structure via the exhaust line, is electrically connected to the at least one pressure sensor; the back pressure regulator opening the exhaust line to relieve the pressure in the feed pipe when the pressure, in the feed pipe detected by the at least one pressure sensor, is higher than a maximum value of the preset operating pressure; the back pressure regulator closing the exhaust line to keep an operating pressure in the feed pipe in tolerant pressure range when the pressure, in the feed pipe detected by the at least one pressure sensor, is lower than a minimum value of the preset operating pressure.

10. A supercritical fluid microcellular injection molding equipment comprising:
an actuating unit;
a feed pipe axially fixed to the actuating unit, a discharge runner axially defined in a front end of the feed pipe;
a metering screw rotatably received in the feed pipe, the metering screw axially connected to the actuating unit and driven by the actuating unit;
a hopper mounted on the feed pipe and feeding polymers into the feed pipe;
an injection valve mounted on the feed pipe;
a high pressure gas source connected to the injection valve, a pressure reducing valve disposed between the injection valve and the high pressure gas source, wherein the pressure reducing valve depressurizes the high pressure liquid gas, supplied from the high pressure gas source, into a gas-liquid coexistent supercritical state and injected into the feed pipe through the injection valve, and the metering screw mixes the SCF with the hot molten polymer into a homogeneous monophasic fluid;
a first gear pump and a second gear pump sequentially mounted to the front end of the feed pipe; the first gear pump and the second gear pump provided with a feed end and a discharge end respectively, wherein the feed end of the first gear pump and the discharge runner are interconnected, and the discharge end of the first gear pump is connected to the feed end of the second gear pump;
a die head mounted onto the discharged end of the second gear pump for injection molding, wherein a feed rate of the second gear pump is higher than a discharge rate of the first gear pump.

11. The equipment as defined in claim 10, wherein the first gear pump and the second gear pump have a same feed-discharge ratio, and a rotary speed of the second gear pump is higher than that of the first gear pump.

12. The equipment as defined in claim 10, wherein the first gear pump and the second gear pump have a same rotary speed, and a feed-discharge ratio of the second gear pump is higher than that of the first gear pump.

13. The equipment as defined in claim 10, wherein the feed pipe is provided with at least one pressure sensor and an exhaust structure; the exhaust structure having an exhaust line connected thereto and a back pressure regulator disposed on the exhaust line, the back pressure regulator connected to the exhaust structure via the exhaust line and electrically connected to the at least one pressure sensor; the back pressure regulator opening the exhaust line to relieve the pressure in feed pipe when the pressure, in feed pipe detected by the at least one pressure sensor, is higher than the maximum value of the preset operating pressure; the back pressure regulator the exhaust line to keep the operating pressure in feed pipe in a tolerant pressure range.

14. The equipment as defined in claim 11, wherein the feed pipe is provided with at least one pressure sensor and an exhaust structure; the exhaust structure having an exhaust line connected thereto and a back pressure regulator disposed on the exhaust line, the back pressure regulator connected to the exhaust structure via the exhaust line and electrically connected to the at least one pressure sensor; the back pressure regulator opening the exhaust line to relieve the pressure in feed pipe when the pressure, in feed pipe detected by the at least one pressure sensor, is higher than the maximum value of the preset operating pressure; the back pressure regulator the exhaust line to keep the operating pressure in feed pipe in a tolerant pressure range.

15. The equipment as defined in claim 12, wherein the feed pipe is provided with at least one pressure sensor and an exhaust structure; the exhaust structure having an exhaust line connected thereto and a back pressure regulator disposed on the exhaust line, the back pressure regulator connected to the exhaust structure via the exhaust line and electrically connected to the at least one pressure sensor; the back pressure regulator opening the exhaust line to relieve the pressure in feed pipe when the pressure, in feed pipe detected by the at least one pressure sensor, is higher than the maximum value of the preset operating pressure; the back pressure regulator the exhaust line to keep the operating pressure in feed pipe in a tolerant pressure range.

16. The equipment as defined in claim 13, wherein a shut-off valve is mounted in the discharge runner and interrupts the discharge runner temporarily and selectively.

17. The equipment as defined in claim 14, wherein a shut-off valve is mounted in the discharge runner and interrupts the discharge runner temporarily and selectively.

18. The equipment as defined in claim 15, wherein a shut-off valve is mounted in the discharge runner and interrupts the discharge runner temporarily and selectively.

19. The equipment as defined in claim 17 further comprising a leveling device coupled with the die head, wherein the leveling device comprises multiple rotating rollers situated on a same plan and synchronously operated; the cooled plate, injected by the die head, crossing the multiple rotating rollers in waves for leveling operation, and eliminating a stress of the plate after molding and the warpage resulted from the stress.

20. The equipment as defined in claim 18 further comprising a leveling device coupled with the die head, wherein the leveling device comprises multiple rotating rollers situated on a same plan and synchronously operated; the cooled plate, injected by the die head, crossing the multiple rotating rollers in waves for leveling operation, and eliminating a stress of the plate after molding and the warpage resulted from the stress.
